(19) United States
(12) Patent Application Publication
(10) Pub. No.: US 2013/0167007 A1
(43) Pub. Date: Jun. 27, 2013

(54) INFORMATION PROCESSING APPARATUS AND INFORMATION PROCESSING METHOD

(71) Applicant: Hideyuki TSUTSUMITAKE, Kanagawa (JP)

(72) Inventor: Hideyuki TSUTSUMITAKE, Kanagawa (JP)

(73) Assignee: Kabushiki Kaisha Toshiba, Tokyo (JP)

(21) Appl. No.: 13/612,431

(22) Filed: Sep. 12, 2012

(30) Foreign Application Priority Data
Dec. 27, 2011 (JP) 2011-286072

(51) Int. Cl. G06F 17/00

(52) U.S. Cl. 715/234

(57) ABSTRACT

According to one embodiment, an information processing method includes: receiving a first structured document comprising an element to be displayed; analyzing the first structured document; extracting an element undisplayable in an information processing apparatus out of the element comprised in the first structured document based on an analysis result of the first structured document; generating a second structured document by converting the element extracted out of the element comprised in the first structured document into an alternative element different from the element extracted; displaying a document image in which an element comprised in the second structured document is arranged on a display based on the second structured document; generating a third structured document comprising the element extracted; notifying an external device of information indicating the third structured document is generated; and distributing the third structured document to the external device in response to a distribution request from the external device.

### CROSS-REFERENCE TO RELATED APPLICATIONS

This application is based upon and claims the benefit of priority from Japanese Patent Application No. 2011-286072, filed on Dec. 27, 2011, the entire contents of which are incorporated herein by reference.

### FIELD

Embodiments described herein relate generally to an information processing apparatus and an information processing method.

### BACKGROUND

Recently, users have increasingly come to use television sets for browsing web pages on the Internet that are conventionally browsed with personal computers (PCs), mobile phones, smart phones, and the like, by connecting the television sets to communication lines such as a broadband line.

When browsing web pages on the Internet with a television set, the user generally operates the television set using a remote controller that comes with the television set. The remote controller is low in operability compared with the case that the web pages on the Internet are browsed by operating a PC with the use of a mouse, a keyboard, a touch screen, or the like of the PC. Some of the remote controllers for operating television sets have operability equivalent to that of the mouse with gravity/acceleration sensors mounted thereon. However, when characters are input, the remote controllers are inferior in operability compared with keyboards or touch screens.

Furthermore, household electrical appliances such as television sets have central processing units (CPUs) with lower performance than that of PCs or smart phones. Hence, web pages prepared with the intention of being displayed on PCs or smart phones cannot be browsed on the television sets sufficiently.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an information browsing system according to an embodiment;

FIG. 2 is an exemplary flowchart illustrating the flow of display processing of a document image based on a first structured document or a second structured document and the flow of distribution processing of a third structured document in the embodiment;

FIG. 3 is a schematic view illustrating one example of the first structured document received in the embodiment;

FIG. 4 is a schematic view illustrating one example of a document image generated based on the first structured document in the embodiment;

FIG. 5 is a schematic view illustrating one example of a document image generated based on the second structured document in the embodiment and one example of a document image based on the third structured document in the embodiment;

FIG. 6 is a schematic view illustrating one example of a document image generated based on the second structured document and one example of a document image based on the third structured document in the embodiment; and

FIG. 7 is a schematic view illustrating one example of a document image generated based on the second structured document and one example of a document image based on the third structured document in the embodiment.

### DETAILED DESCRIPTION

In general, according to one embodiment, an information processing apparatus comprises: a first communication module configured to receive a first structured document comprising an element to be displayed; an analyzer configured to analyze the first structured document to generate an analysis result of the first structured document; an element extractor configured to extract an element which is not displayable in the information processing apparatus out of the element comprised in the first structured document based on the analysis result of the first structured document; an element convertor configured to generate a second structured document by converting the element extracted out of the element comprised in the first structured document into an alternative element different from the element extracted; a display controller configured to display a document image in which an element comprised in the second structured document is arranged on a display based on the second structured document; an element generator configured to generate a third structured document comprising the element extracted; a second communication module configured to notify an external device of information indicating the third structured document is generated; and a distribution module configured to distribute the third structured document to the external device in response to a distribution request from the external device.

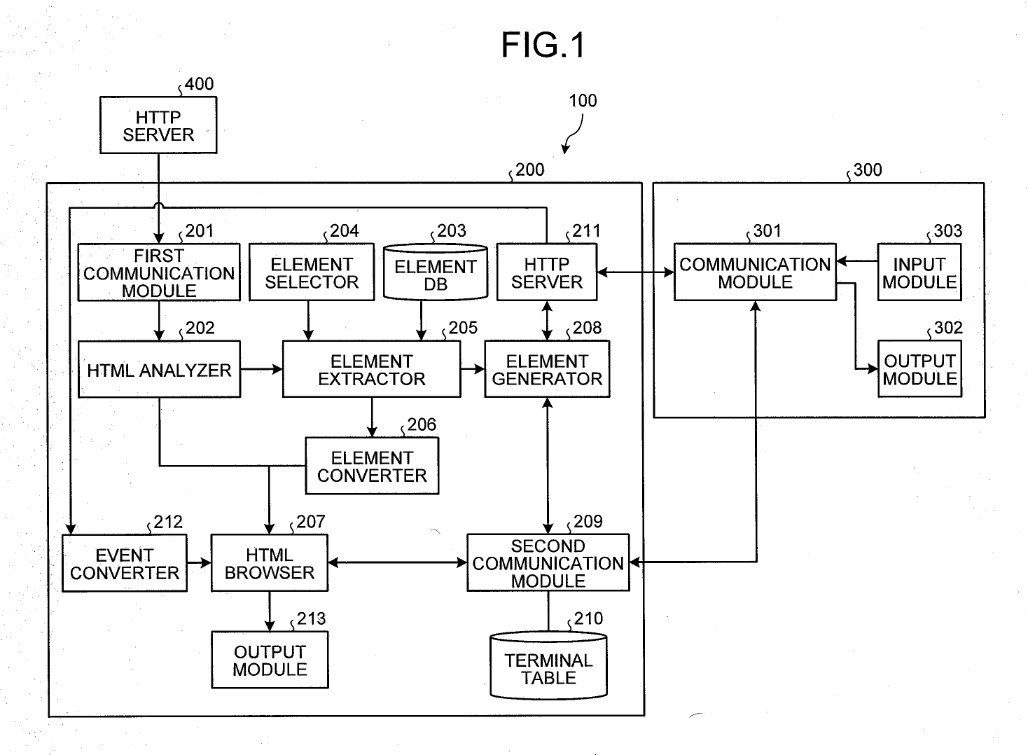

An information browsing system comprising an information processing apparatus according to an embodiment is explained. FIG. 1 is a schematic block diagram of the information browsing system.

An information browsing system 100 illustrated in FIG. 1 comprises a receiver 200 such as a television receiver that is an information processing apparatus, a user terminal device 300 as a predetermined external device such as a tablet terminal device or a smart phone, and a hyper text transfer protocol (HTTP) server 400 as an external server that is connected to a network (not illustrated in the drawings) such as the Internet and distributes structured documents such as hyper text markup language (HTML) pages in response to a request from the receiver 200. Here, the structured document is a document comprising elements to be displayed (images or moving pictures, for example) such as HTML pages and being structured.

In FIG. 1, although only one HTTP server 400 is illustrated, a plurality of HTTP servers 400 are also available. Here, the HTTP server 400 is connected with the receiver 200 via a network (not illustrated in the drawings) such as the Internet. The receiver 200 and the user terminal device 300 are connected with each other by using a wireless local area network (LAN) or the Bluetooth (registered trademark).

The receiver 200 comprises, as illustrated in FIG. 1, a first communication module 201, an HTML analyzer 202, an element data base (DB) 203, an element selector 204, an element extractor 205, an element convertor 206, an HTML browser 207, an element generator 208, a second communication module 209, a terminal table 210, an HTTP server 211, an event convertor 212, and an output module 213. Here, when the receiver 200 is a television receiver, the other constitution of the receiver 200 is, for example, the same as that of a conventional digital television receiver.

The first communication module 201 communicates with the HTTP server 400, specifies the uniform resource locator (URL) of a web site on a network (not illustrated in the drawings), requests the acquisition of a structured document, and receives the structured document (hereinafter, referred to as a “first structured document”) from the HTTP server 400.

The HTML analyzer 202 analyzes the first structured document received by the first communication module 201. To be more specific, the HTML analyzer 202 analyzes the layout of various elements comprised in the first structured document received or tags comprised in the elements that the first structured document received comprises.

The element data base (DB) 203 stores therein a table storing therein element information indicating elements undisplayable in the receiver 200 (own apparatus). Examples of the elements undisplayable in the receiver 200 include an element for displaying a user interface for inputting information such as a graphical user interface (GUI), an element for displaying a plug-in, which cannot be executed in the own apparatus, for reproducing videos of Flash or CODEC, an element for displaying an image formed by reproducing a video stream received from an external server.

The element selector 204 selects, responding to an operation from a remote controller (not illustrated in the drawings) for operating the receiver 200, the element undisplayable in the receiver 200 out of the elements that the first structured document received by the first communication module 201 comprises.

The element extractor 205 extracts the element undisplayable in the receiver 200, out of the elements comprised in the first structured document received by the first communication module 201, based on the results of analyzing the first structured document by the HTML analyzer 202. To be more specific, the element extractor 205 extracts the element undisplayable in the own apparatus, out of the elements comprised in the first structured document, based on the results of analyzing the tags comprised in the elements that the first structured document comprises.

In the present embodiment, the element extractor 205 reads out the element information from the table stored in the element DB 203 and extracts the element that the element information read out indicates, out of the elements comprised in the first structured document received by the first communication module 201. Otherwise the element extractor 205 extracts the element selected by the element selector 204, out of the elements comprised in the first structured document received by the first communication module 201.

The element convertor 206 generates a structured document (hereinafter, referred to as a “second structured document”) by converting the element extracted by the element extractor 205, out of the elements comprised in the first structured document received by the first communication module 201, into an alternative element (a message for notifying information that the element extracted by the element extractor 205 cannot be displayed, or the like, for example) different from the element extracted by the element extractor 205.

The HTML browser 207 controls the display of the first structured document received by the first communication module 201. To be more specific, the HTML browser 207 generates, based on the results of analyzing the first structured document by the HTML analyzer 202, a document image in which the elements comprised in the first structured document received are arranged, and displays the document image generated on the output module 213. Here, the HTML browser 207 is realized by a browser program for controlling the display of the structured document, wherein the browser program is executed by a controller comprised of a central processing unit (CPU), a memory, and the like that are not illustrated in the drawings.

Furthermore, when the element undisplayable in the receiver 200 is extracted, the HTML browser 207 displays, based on the second structured document generated by the element convertor 206, a document image in which elements comprised in the second structured document are arranged on the output module 213 (display). To be more specific, the HTML browser 207 analyzes the second structured document received, generates the document image in which the elements comprised in the second structured document received are arranged based on the result of analyzing the second structured document received, and displays the document image generated on the output module 213. That is, the HTML browser 207 corresponds to a display controller. Here, the output module 213 comprises a liquid crystal display (display) and a speaker.

In addition, the HTML browser 207 functions as an event controller that reflects an event output from the event convertor 212 described later in the document image to be displayed on the output module 213.

The element generator 208 generates a structured document (hereinafter, referred to as a “third structured document”) that comprises the element extracted by the element extractor 205. In the present embodiment, the element generator 208 generates the third structured document that comprises an element generated by converting the element extracted by the element extractor 205 into such a form that the element extracted by the element extractor 205 can be displayed on the user terminal device 300. Furthermore, the element generator 208 outputs the third structured document generated to the HTTP server 211 and, at the same time, generates a virtual URL that specifies the directory of the third structured document generated in the HTTP server 211 to output the virtual URL generated to the HTTP server 211 and the second communication module 209.

The terminal table 210 stores therein device information (the e-mail address, the IP address, or the like of the user terminal device 300, for example) indicating a predetermined external device notifying of the information that the third structured document is generated by the element generator 208.

The second communication module 209 communicates with the user terminal device 300 by using the wireless LAN or the Bluetooth (registered trademark). To be more specific, the second communication module 209 notifies, when the third structured document is generated by the element generator 208, the user terminal device 300 of the information that the third structured document is generated by the element generator 208 by using the WebSocket, the e-mail, the IP Messenger, or the like. In the present embodiment, the second communication module 209 reads out the device information from the terminal table 210 and notifies the external device (user terminal device 300) indicated by the device information read out thereby of the information that the third structured document is generated by the element generator 208. The second communication module 209 also notifies, when notifying the information that the third structured document is generated by the element generator 208, the user terminal device 300 of the virtual URL of the third structured document generated.

Here, in the present embodiment, although the second communication module 209 notifies only one external device (user terminal device 300) of the information that the third structured document is generated by the element generator 208, the present embodiment is not limited to the case above. The second communication module 209 may notify two or more external devices of the information that the third structured document is generated by the element generator 208.

The HTTP server 211 receives and stores therein the third structured document generated by the element generator 208 and the virtual URL of the third structured document. Furthermore, the HTTP server 211 functions as a distribution module that distributes the third structured document generated by the element generator 208 to the user terminal device 300 in response to a distribution request from the user terminal device 300. Here, in the present embodiment, the HTTP server 211 specifies the third structured document to be distributed to the user terminal device 300 out of the third structured documents stored therein based on the virtual URL comprised in the distribution request from the user terminal device 300, and distributes the third structured document specified thereby to the user terminal device 300.

Furthermore, it is also possible for the HTTP server 211 to encode, in distributing the third structured document generated by the element generator 208 to the user terminal device 300, the third structured document generated by the element generator 208 and distribute the third structured document encoded thereby to the user terminal device 300. In this case, the HTTP server 211 also functions as an encoding module. Here, as a method for encoding in encoding the third structured document, a conventionally-used method for encoding is used in communicating data.

In addition, the HTTP server 211 receives an event (information comprised in the third structured document generated by the element generator 208, such as a character string input by an element for displaying a user interface, for example) and transmits the event received thereby to the event convertor 212.

The event convertor 212 converts the event received thereby into such a form that the event can be displayed on the receiver 200 and transmits the event to the HTML browser 207. The HTML browser 207 receives the event from the event convertor 212 and reflects the event received thereby in a content (document image) to be displayed on the output module 213.

Next, the user terminal device 300 is explained. The user terminal device 300 comprises, as illustrated in FIG. 1, a communication module 301, an output module 302, and an input module 303. Here, when the user terminal device 300 is a tablet terminal device, the other detailed constitution of the user terminal device 300 is, for example, the same as that of the conventional tablet terminal device. In FIG. 1, although one user terminal device 300 is illustrated, a plurality of user terminal devices 300 are conceivable.

The input module 303 is an input device such as a touch panel or a key input module, and used for inputting information by users. The output module 302 is an output device such as a display or a speaker, and used for outputting various kinds of information.

The communication module 301 communicates with the receiver 200 by using the wireless LAN, the Bluetooth (registered trademark), or the like. To be more specific, the communication module 301 receives the notification that the third structured document is generated by the element generator 208 and the notification of the virtual URL of the third structured document generated by the element generator, 208 by using the WebSocket, the e-mail, the IP Messenger, or the like. The communication module 301 accesses, in response to the instruction from the input module 303, the HTTP server 211 of the receiver 200 by using the virtual URL received thereby to request the distribution of the third structured document and receive the third structured document distributed from the HTTP server 211.

Furthermore, the communication module 301 also comprises a function as an HTML browser that controls of displaying the third structured document distributed from the HTTP server 211. Here, in the same manner as the case of the HTML browser 207 comprised in the receiver 200, the communication module 301 as the HTML browser is realized by a browser program for controlling the display of the third structured document, wherein the browser program is executed by a controller comprised of a CPU, a memory, and the like that are not illustrated in the drawings.

In addition, the communication module 301 as the HTML browser performs display control for displaying the third structured document distributed from the HTTP server 211 on the output module 302 (display). To be more specific, the HTML browser 207 analyzes the third structured document received thereby, generates a document image in which the elements comprised in the third structured document received thereby are arranged based on the results of analyzing the third structured document, and displays the document image generated thereby on the output module 302 (display). The communication module 301 as the HTML browser notifies, when the event such that information input from the input module 303 is accepted occurs in the element for displaying the user interface out of the elements comprised in the document image based on the structured document displayed on the output module 302, the HTTP server 211 in the receiver 200 of the event indicating the information accepted thereby.

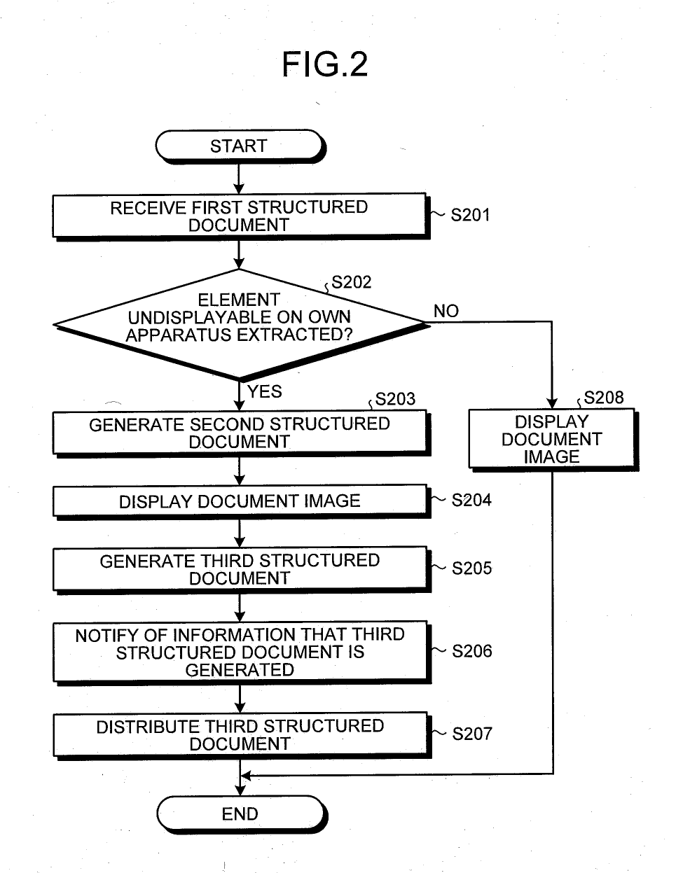

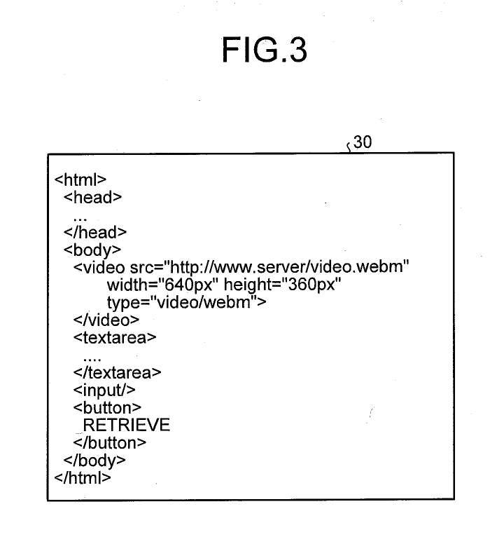

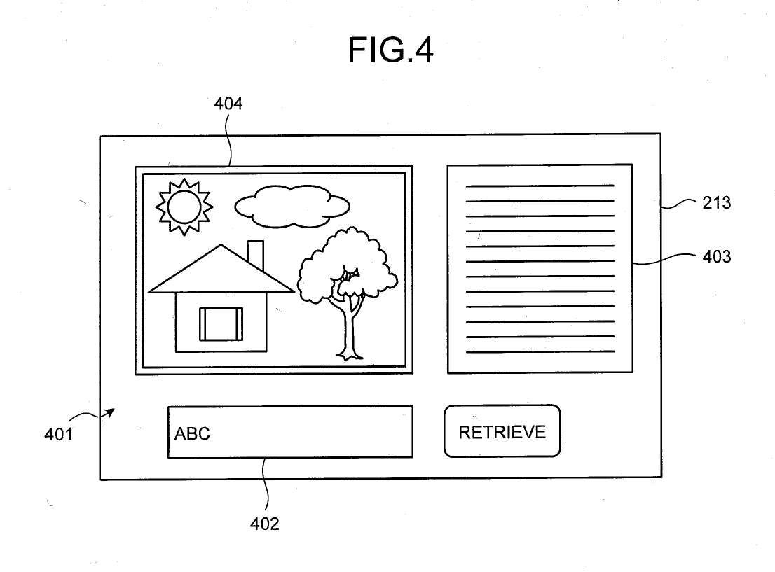

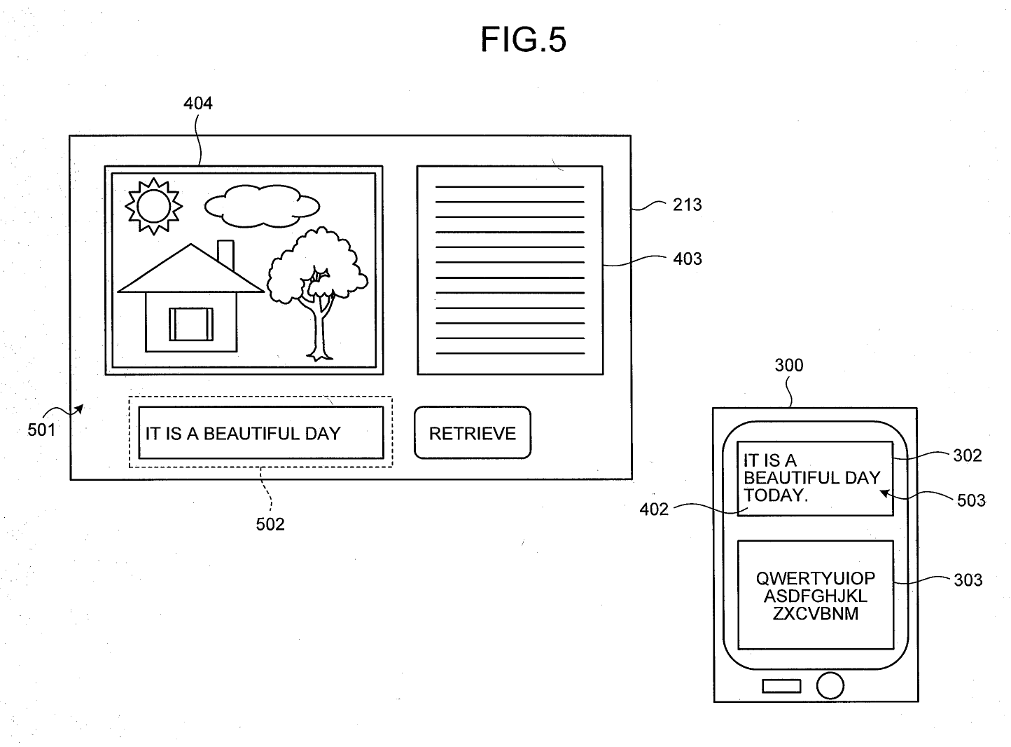

Next, in conjunction with FIGS. 2 to 7, the flow of display processing of the document image based on the first structured document or the second structured document and the flow of distribution processing of the third structured document are explained. FIG. 2 is a flowchart illustrating the flow of the display processing of the document image based on the first structured document or the second structured document and the flow of the distribution processing of the third structured document. FIG. 3 is a schematic view illustrating one example of the first structured document received by the first communication module 201. FIG. 4 is a schematic view illustrating one example of the document image generated based on the first structured document. FIGS. 5 to 7 are schematic views each illustrating one example of the document image generated based on the second structured document and one example of the document image based on the third structured document.

First of all, the first communication module 201 communicates with the HTTP server 400 to receive a first structured document 30 (see FIG. 3) from the HTTP server 400 (S201). Here, in the first structured document 30 illustrated in FIG. 3, the tag of <video . . . /> comprised in the element for displaying a video, the tag of <textarea/> comprised in the element for displaying a document, the tag of <input/> comprised in the element for inputting characters, the tag of <button/> comprised in the element for executing an action (retrieval operation, for example), and the like are described.

The first communication module 201 receives the first structured document, and the HTML analyzer 202 analyzes the first structured document received by the first communication module 201. The element extractor 205 performs processing of extracting the element undisplayable in the receiver 200 out of the elements comprised in the first structured document based on the results of analyzing the first structured document (S202). Here, when the element undisplayable in the receiver 200 is not extracted (No at S202), the HTML browser 207 generates, based on the results of analyzing the first structured document 30 received by the first communication module 201, a document image 401 in which elements (a video display element 404, a character display element 403, and a character input element 402) comprised in the first structured document 30 received by the first communication module 201 are arranged, and displays the document image 401 (see FIG. 4) generated thereby on the output module 213 (S208).

On the other hand, when a character input element (an element comprising the tag of <input/> in the first structured document 30) for displaying the user interface for inputting the character string is extracted from the first structured document 30 as an element that cannot be received by the receiver 200 (Yes at S202), the element convertor 206 generates a second structured document by converting the character input element 402, out of the elements comprised in the first structured document 30 received by the first communication module 201, into an alternative element 502 (a message indicating an area for inputting the character string, for example) different from the character input element 402 (S203).

The HTML browser 207 analyzes the second structured document generated. The HTML browser 207 generates, based on the results of analyzing the second structured document, a document image 501 in which the elements (the video display element 404, the character display element 403, and the alternative element 502) comprised in the second structured document are arranged, and displays the document image 501 generated thereby on the output module 213 (S204) (see FIG. 5).

Furthermore, the element generator 208 generates, when the character input element 402 is extracted as an element undisplayable in the own apparatus, a third structured document by converting the character input element 402 into such a form that the character input element 402 can be displayed on the user terminal device 300 (S205). The second communication module 209 notifies, when the third structured document is generated, the user terminal device 300 of the information that the third structured document is generated and the virtual URL of the third structured document (S206). Thereafter, when receiving the virtual URL specified by the user terminal device 300 and the request of distributing the third structured document from the user terminal device 300, the HTTP server 211 distributes the third structured document designated by the virtual URL to the user terminal device 300 (S207).

In the user terminal device 300 that receives the distribution of the third structured document, the communication module 301 analyzes the third structured document distributed from the HTTP server 211, and displays a document image 503 in which the character input element 402 comprised in the third structured document distributed is arranged on the output module 302 based on the results of analyzing the third structured document (see FIG. 5). Furthermore, the communication module 301 notifies, when the event such that a character string input from the input module 303 is accepted occurs in the character input element 402, the HTTP server 211 in the receiver 200 of the event indicating the character string (“It is a beautiful day.” or the like, for example) accepted.

The HTTP server 211 receives the notification of the event from the user terminal device 300 and transmits the event received thereby to the event convertor 212. The event convertor 212 converts the event received thereby into such form that the event can be displayed on the receiver 200 to transmit the event to the HTML browser 207. The HTML browser 207 displays the character string (“It is a beautiful day.” or the like, for example) that the event received thereby indicates as the alternative element 502 of the document image 501 generated based on the second structured document on the output module 213.

Furthermore, when a character display element (an element comprising the tag of <textarea/> in the first structured document 30) for displaying a document is extracted from the first structured document 30 received as an element that cannot be received by the receiver 200 (Yes at S202), the element convertor 206 generates a second structured document by converting the character display element 403, out of the elements comprised in the first structured document 30 received by the first communication module 201, into an alternative element 603 (a message indicating an area for displaying a document, for example) different from the character display element 403 (S203).

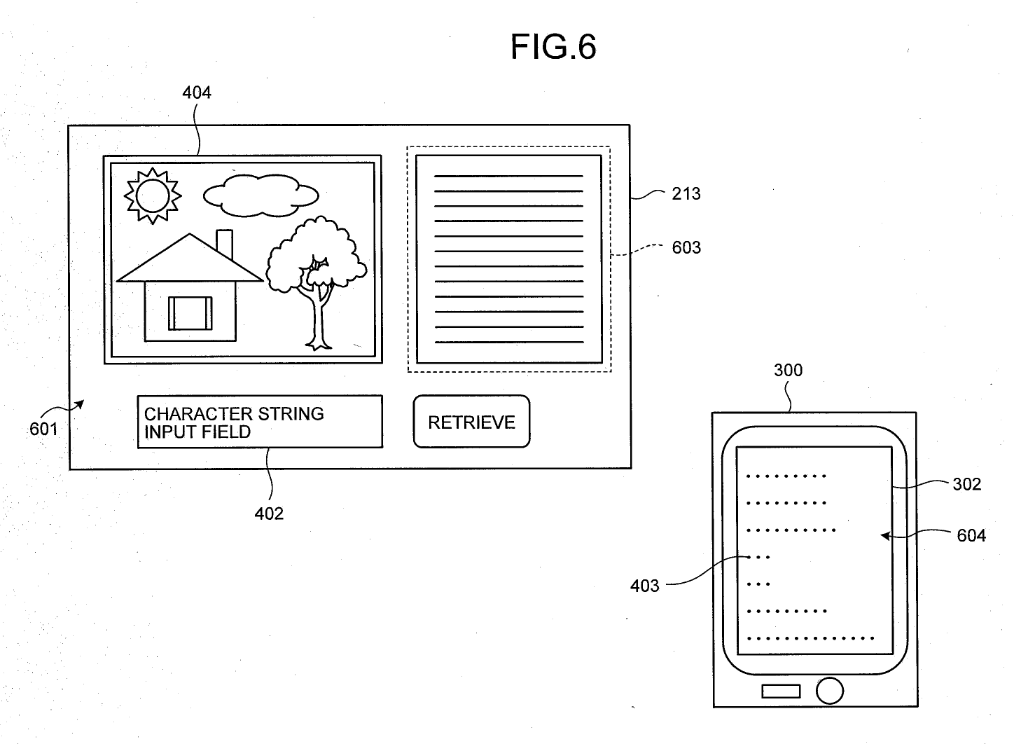

The HTML browser 207 analyzes the second structured document generated. The HTML browser 207 generates, based on the results of analyzing the second structured document, a document image 601 in which the elements (the video display element 404, the character input element 402, and the alternative element 603) comprised in the second structured document are arranged, and displays the document image 601 generated thereby on the output module 213 (S204) (see FIG. 6).

Furthermore, the element generator 208 generates, when the character display element 403 is extracted as an element undisplayable in the own apparatus, a third structured document by converting the character display element 403 into such a form that the character display element 403 can be displayed on the user terminal device 300 (S205). The second communication module 209 notifies, when the third structured document is generated, the user terminal device 300 of the information that the third structured document is generated and the virtual URL of the third structured document (S206). Thereafter, when receiving the virtual URL specified by the user, terminal device 300 and the request of distributing the third structured document from the user terminal device 300, the HTTP server 211 distributes the third structured document designated by the virtual URL to the user terminal device 300 (S207).

In the user terminal device 300 that receives the distribution of the third structured document, the communication module 301 analyzes the third structured document distributed from the HTTP server 211. The communication module 301 displays, based on the results of analyzing the third structured document, a document image 604 in which the character display element 403 comprised in the third structured document distributed is arranged on the output module 302 (see FIG. 6). In the user terminal device 300, the character display element 403 can be scrolled by operating the input module 303.

Furthermore, when the character display element (the element comprising the tag of <video . . . > in the first structured document 30) for displaying a document is extracted from the first structured document 30 received as an element that cannot be received by the receiver 200 (Yes at S202), the element convertor 206 generates a second structured document by converting the video display element 404, out of the elements comprised in the first structured document 30 received by the first communication module 201, into an alternative element 702 (a message indicating an area for displaying a video, for example) different from the video display element 404 (S203).

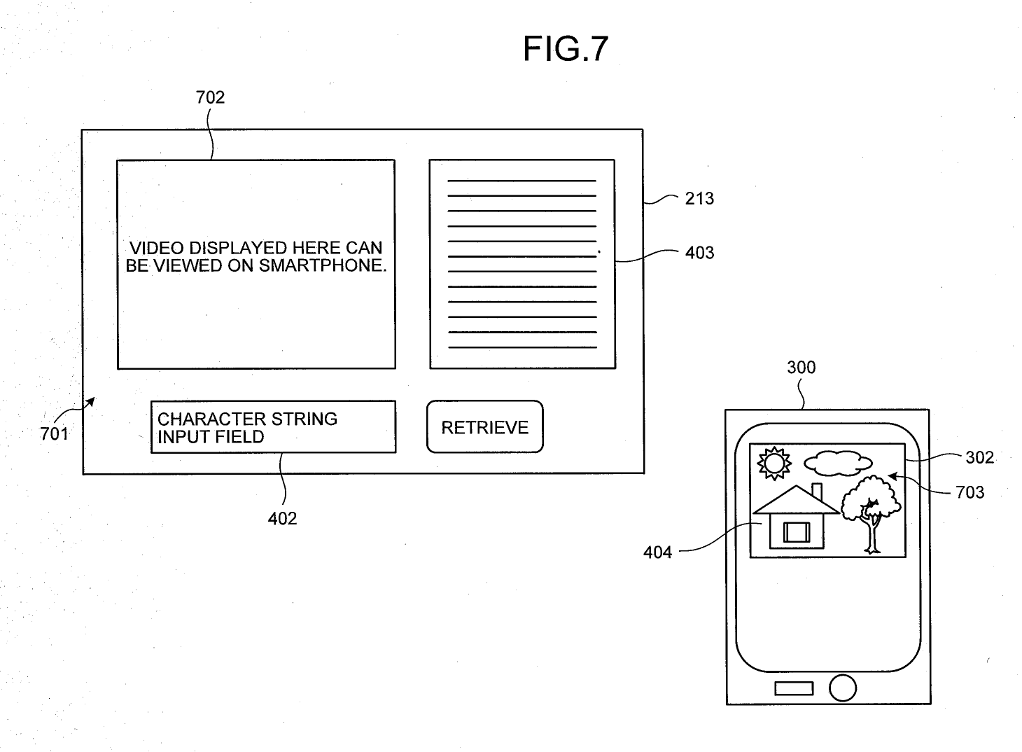

The HTML browser 207 analyzes the second structured document generated. The HTML browser 207 generates, based on the results of analyzing the second structured document, a document image 701 in which the elements (the alternative element 702, the character display element 403, and the character input element 402) comprised in the second structured document are arranged, and displays the document image 701 generated thereby on the output module 213 (S204) (see FIG. 7).

Furthermore, the element generator 208 generates, when the video display element 404 is extracted as an element undisplayable in the own apparatus, the third structured document by converting the video display element 404 into such a form that the video display element 404 can be displayed on the user terminal device 300 (S205). The second communication module 209 notifies, when the third structured document is generated, the user terminal device 300 of the information that the third structured document is generated and the virtual URL of the third structured document (S206). Thereafter, when receiving the virtual URL specified by the user terminal device 300 and the request of distributing the third structured document from the user terminal device 300, the HTTP server 211 distributes the third structured document designated by the virtual URL to the user terminal device 300 (S207).

In the user terminal device 300 that receives the distribution of the third structured document, the communication module 301 analyzes the third structured document distributed from the HTTP server 211. The communication module 301 displays, based on the results of analyzing the third structured document, a document image 703 in which the video display element 404 comprised in the third structured document distributed is arranged on the output module 302.

Due to such steps, according to the receiver 200 of the present embodiment, since the first communication module 201 that receives the first structured document comprising elements to be displayed, the HTML analyzer 202 that analyzes the first structured document received, the element extractor 205 that extracts, based on the results of analyzing the first structured document, the element undisplayable in the receiver 200 out of the elements comprised in the first structured document, the element convertor 206 that generates the second structured document by converting the element extracted, out of the elements comprised in the first structured document, into the alternative element different from the element extracted, the HTML browser 207 that displays, based on the second structured document, the document image in which the elements comprised in the second structured document are arranged on the output module 213, the element generator 208 that generates the third structured document comprising the element extracted, the second communication module 209 that notifies the user terminal device 300 of the information that the third structured document is generated, and the HTTP server 211 that distributes the third structured document to the user terminal device 300 in response to the request of distributing the third structured document from the user terminal device 300 are provided, the element undisplayable in the receiver 200 can be browsed on the user terminal device 300 thus improving operability in browsing the structured documents. Furthermore, even when it is difficult to input information on the receiver 200, the information can be input by cooperating with the user terminal device 300. In addition, a video stream, an application, or the like undisplayable in the receiver 200 is displayed on the user terminal device 300 thus displaying all elements comprised in the first structured documents distributed from providing sources. Furthermore, when an element undisplayable in the receiver 200 is extracted and the third structured document is generated, the third structured document can be browsed immediately on the user terminal device 300 by notifying the user terminal device 300 of the information that the third structured document is generated.

Here, a program executed in the receiver 200 of the present embodiment is provided in the form of the read only memory (ROM) or the like into which the program is integrated in advance.

The program executed in the receiver 200 of the present embodiment may be provided in the form of the storage medium capable of being read by the computer; that is, a compact disc-read only memory (CD-ROM), a flexible disk (FD), a compact disc-recordable (CD-R), the digital versatile disk (DVD), or the like in which the program is stored in an installable or executable file.

In addition, the program executed in the receiver 200 of the present embodiment may be stored on the computer connected to a network such as the Internet and provided by downloading via the network. The program executed in the receiver 200 of the present embodiment may be provided or distributed via a network such as the Internet.

The program executed in the receiver 200 of the present embodiment is constituted of modules comprising the above-mentioned respective modules (the first communication module 201, the HTML analyzer 202, the element selector 204, the element extractor 205, the element convertor 206, the HTML browser 207, the element generator 208, the second communication module 209, the HTTP server 211, the event convertor 212, and the like). As actual hardware, a processor (CPU) reads out the program from the above-mentioned ROM to execute the program, and thus the above-mentioned respective modules are loaded on a main memory, and the first communication module 201, the HTML analyzer 202, the element selector 204, the element extractor 205, the element convertor 206, the HTML browser 207, the element generator 208, the second communication module 209, the HTTP server 211, the event convertor 212, and the like are generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first communication module configured to receive a first structured document comprising an element to be displayed;
an analyzer configured to analyze the first structured document to generate an analysis result of the first structured document;
an element extractor configured to extract an element which is not displayable in the information processing apparatus out of the element comprised in the first structured document based on the analysis result of the first structured document;
an element convertor configured to generate a second structured document by converting the element extracted out of the element comprised in the first structured document into an alternative element different from the element extracted;
a display controller configured to display a document image in which an element comprised in the second structured document is arranged on a display based on the second structured document;
an element generator configured to generate a third structured document comprising the element extracted;
a second communication module configured to notify an external device of information indicating the third structured document is generated; and
distribution module configured to distribute the third structured document to the external device in response to a distribution request from the external device.

2. The information processing apparatus of claim 1, wherein the element extractor is configured to read out element information indicating the element which is not displayable in the information processing apparatus from a table storing therein the element information and extract an element indicated by the element information read out, out of the element comprised in the first structured document.

3. The information processing apparatus of claim 1, further comprising:
an element selector configured to select the element which is not displayable in the information processing apparatus, wherein
the element extractor is configured to extract the selected element out of the element comprised in the first structured document.

4. The information processing apparatus of claim 1, wherein
the analyzer is configured to analyze a tag comprised in the element comprised in the first structured document to generate an analysis result of the tag, and
the element extractor is configured to extract the element which is not displayable in the information processing apparatus out of the element comprised in the first structured document based on the analysis result of the tag.

5. The information processing apparatus of claim 1, wherein the element extractor is configured to extract an element for displaying a user interface for inputting information out of the element comprised in the first structured document.

6. The information processing apparatus of claim 3, wherein the element extractor is configured to extract an element for displaying a plug-in which cannot be executed by the information processing apparatus out of the element comprised in the first structured document.

7. The information processing apparatus of claim 3, wherein the element extractor is configured to extract an element for displaying an image obtained by reproducing a video stream received from a server, out of a plurality of elements described in the first structured document.

8. The information processing apparatus of claim 1, wherein the distribution module is configured to encode the third structured document to distribute the encoded third structured document to the external device.

9. An information processing method, the method executed in an information processing apparatus, the method comprising:
receiving, by a first communication module, a first structured document comprising an element to be displayed;
analyzing, by an analyzer, the first structured document to generate an analysis result of the first structured document;
extracting, by an element extractor, an element which is not displayable in the information processing apparatus out of the element comprised in the first structured document based on the analysis result of the first structured document;
generating, by an element convertor, a second structured document by converting the element extracted out of the element comprised in the first structured document into an alternative element different from the element extracted;
displaying, by a display controller, a document image in which an element comprised in the second structured document is arranged on a display based on the second structured document;
generating, by an element generator, a third structured document comprising the element extracted;
notifying, by a second communication module, an external device of information indicating the third structured document is generated; and
distributing, by a distribution module, the third structured document to the external device in response to a distribution request from the external device.
